(19) United States
(12) Patent Application Publication
(10) Pub. No.: US 2005/0210028 A1
(43) Pub. Date: Sep. 22, 2005

(54) Data write protection in a storage area network and network attached storage mixed environment

(76) Inventor: Shoji Kodama, San Jose, CA (US)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 10/802,853

(22) Filed: Mar. 18, 2004

(51) Int. Cl. G06F 12/00

(52) U.S. Cl. 707/9; 707/200

(57) ABSTRACT

A storage system and method for protecting data on a physical volume at the file system level and permitting access to the data at the physical volume level. The storage system includes a first interface for file level I/O, a second interface for block level I/O, plural physical volumes upon which logical volumes are represented and which permit an appropriate sized file system to be created to store archived data, a first controller which processes file level I/O requests, and a second controller which processes block level I/O requests. The first and second controllers share protection information for the logical and physical volumes. Archived data, stored from the first interface and protected at the file level, is accessed from the first and second interfaces, and is protected whichever interface is used. Alternatively a network attached storage (NAS) gateway is included to provide the first interface for file level I/O.

### BACKGROUND OF THE INVENTION

The present invention relates generally to techniques for long term data archiving in a storage system. More particularly the present invention relates to a storage system and method for protecting data on a disk volume at the file system level and permitting access to said data at the volume level.

Conventionally, long term data archiving has been accomplished write once read many (WORM) storage media. Recently the need for long term data archiving has increased. This need has been made more acute, for example, by the passage of various regulations. These regulations include, for example, Regulations like SEC (Securities and Exchange Act) and 21 CFR (Code of Federal Regulations) Part 11 of the Food and Drug Administration act. These regulations require regulated companies to keep data for a long term. An important factor in such regulations is that the data must not be changed during the retention period. As the result, the data need to be stored on WORM storage media.

Logical device (LDEV) Guard disk subsystems have WORM capability. With this capability, if a volume is set to be write-protected, no one can write or change any data stored on the volume. Since data need not to be kept after an expiration of a period required by the regulations, LDEV guard provides a retention period for a volume. After expiration of the retention period, users can then write and change data on the volume. The storage system has an internal timer for this purpose.

However, some regulations require a strict WORM implementation where the WORM setting cannot be altered by anyone in the world. Similarly, such strict WORM implementation requires that the retention period or an internal timer in the storage system cannot be altered.

Further, LDEV guard protects data at a volume level. Sometimes protecting data at the volume level is not useful. Users or archiving software vendors need to develop software that manages volumes and locations of archived data on the volumes. It's better that storage systems provide these capabilities so as not to be of concern to the users or vendors.

Since data is archived at the file level, it is best to protect data at file level. Network Attached Storage (NAS) fits this requirement. In fact some NAS products have WORM capability. When data is copied, moved, or backed up, it is better to move data by using faster and lower overhead networks. Fibre Channel (FC) redundant array of inexpensive disks (RAID) storage system products provide this capability. However, protecting data at the file level and manipulating data at volume level are inconsistent requirements.

As is known protocols such as network file system (NFS), common internet file system (CIFS) or hypertext transport protocol (HTTP) use what is known as a file system interface, whereas protocols such a Ethernet, Fibre Channel, Small Computer Standard Interface (SCSI) or Internet Small Computer Standard Interface (iSCSI) use what is known as a block input/output (I/O) interface.

A NAS gateway provides file level access and file level data protection via the NAS gateway and volume level access to a FC storage system by bypassing the NAS gateway. However, accessing data though a Fibre Channel network or a SAN can alter the protected data, thereby causing the product to not meet the WORM requirements.

### SUMMARY OF THE INVENTION

The present invention provides an apparatus, method and system for protecting data on a disk volume at the file system level and permitting access to the data at the disk volume level.

According to the present invention a first embodiment provides a storage system having two types of interfaces, namely a first interface for file level I/O and a second interface for block level I/O. The storage system manages a pool of physical volumes and creates an appropriate size of a file system to store archived data.

Further, according to the present invention the storage system includes a first controller which processes file level I/O requests and a second controller which processes block level I/O requests. The first controller and the second controller share protection information for logical volumes and physical volumes in the storage system.

As per the present invention archived data is stored from the first interface and protected at file system level, is accessed from both the first interface and the second interface and is protected whichever interfaces are used. Users can create appropriate size of a file system to store the archived data where the file system includes multiple physical volumes.

According to the present invention the second embodiment provides a storage system having the second interface for block level I/O and protection information for physical volumes. According to the present invention a NAS gateway provides a first interface for file level I/O. The NAS gateway manages a pool of physical volumes in the storage system and creates appropriate size of a file system to store archived data. The storage system and NAS gateway are connected via the third interface.

As per the present invention archived data is stored from the first interface. The NAS gateway stores received data via the first interface to physical volumes in the storage system via the third interface. The archived data is protected at file system level. The NAS gateway requests the storage system to protect physical volumes that construct a file system to be protected. Further, the archived data is accessed from both the first interface and the second interface, and is protected for whichever interfaces are used.

### BRIEF DESCRIPTION OF THE DRAWINGS

The foregoing and a better understanding of the present invention will become apparent from the following detailed description of example embodiments and the claims when read in connection with the accompanying drawings, all forming a part of the disclosure of this invention. While the foregoing and following written and illustrated disclosure focuses on disclosing example embodiments of the invention, it should be clearly understood that the same is by way of illustration and example only and the invention is not limited thereto, wherein in the following brief description of the drawings:

FIG. 1 is a diagram for explaining a storage system for protecting data on a disk volume at the file system level and permitting access to the data at the volume level according to a first embodiment of the present invention;

FIG. 2 is a diagram for explaining the relationship between physical volumes, logical volumes and a file system according to the present invention;

FIG. 3 is a diagram for explaining a volume status table according to the present invention;

FIG. 4 is a flowchart illustrating a file create request procedure according to the present invention;

FIG. 5 is a flowchart illustrating a file read request procedure according to the present invention;

FIG. 6 is a flowchart illustrating a file write request procedure according to the present invention;

FIG. 7 is a flowchart illustrating a file delete request procedure according to the present invention;

FIG. 8 is a flowchart illustrating a file copy request procedure according to the present invention;

FIG. 9 is a flowchart illustrating a file move request procedure according to the present invention;

FIG. 10 is a flowchart illustrating a file system protect request procedure according to the present invention;

FIG. 11 is a flowchart illustrating a file system export request procedure according to the present invention;

FIG. 12 is a flowchart illustrating a file system un-export request procedure according to the present invention;

FIG. 13 is a flowchart illustrating a file system create request procedure according to the present invention;

FIG. 14 is a flowchart illustrating a file system delete request procedure according to the present invention;

FIG. 15 is a flowchart illustrating a file system expand request procedure according to the present invention;

FIG. 16 is a flowchart illustrating an expired date check procedure according to the present invention;

FIG. 17 is a flowchart illustrating a data block read request procedure according to the present invention;

FIG. 18 is a flowchart illustrating a data block write request procedure according to the present invention;

FIG. 19 is a flowchart illustrating how to archive files according to the present invention; and

FIG. 20 is a diagram for explaining a storage system for protecting data on a disk volume at the file system level and permitting access to the data at the physical volume level according to a second embodiment of the present invention

### DETAILED DESCRIPTION OF THE INVENTION

The present invention as will be described in greater detail below provides an apparatus, method and system for protecting data on a disk volume at the file system level and permitting access to the data at the volume level. The present invention provides various embodiments as described below. However it should be noted that the present invention is not limited to the embodiments described herein, but could extend to other embodiments as would be known or as would become known to those skilled in the art.

### EMBODIMENT 1

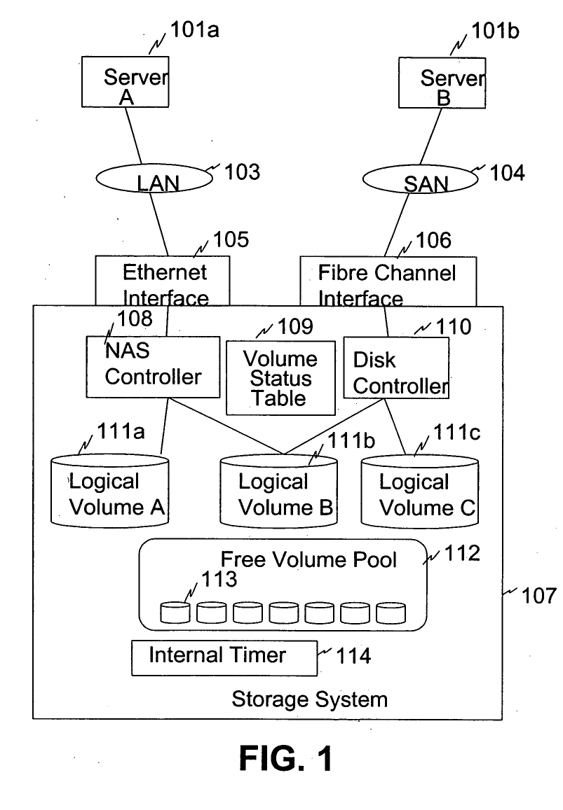

The first embodiment of the present invention as illustrated in FIG. 1 provides a storage system 107 which includes at least one first interface 105 for interfacing to at least one server 101a via a local area network (LAN) 103. The server 101a causes the storage system 107 by request to create, read, write, delete, copy, move and protect files.

The storage system 107 further includes at least one logical volume. In FIG. 1 the storage system 107 includes logical volume A 111a, logical volume B 111b and logical volume C 111c in which file systems are constructed and files are stored. According to the present invention a logical volume includes at least one physical volume. The first interface 105 allows for file system level access to the logical volumes 111a, 111b and 111c.

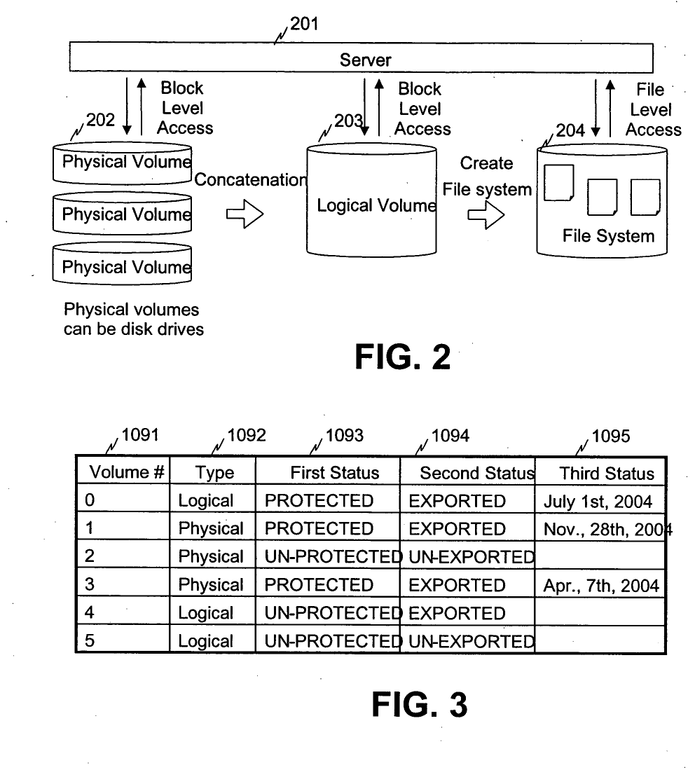

FIG. 2 illustrates the relationship between a file system 204, a logical volume 203 and physical volumes 202 and how such are accessed by a server 201. As per FIG. 2 each logical volume 203 is represented on one or more physical volumes 202. Access to files on the logical volume 203 by the server 201 is performed using the file system 204.

The storage system 107 still further includes a pool of physical volumes 113 that are not used for any purpose and as such are denoted as a free volume pool 112, and at least one second interface 106 for interfacing to at least one server 101b via a storage area network (SAN) 104. The server 101b causes the storage system 107 by request to read data from logical volumes 111a, 111b and 111c and physical volumes 113 in the storage system 107 at the block level.

It should be noted that it may be possible for the second interface 106 to be physically the same as the first interface 105. Further, it should be noted that the first interface could for example be an Ethernet interface or any other such file system type interface and that the second interface could for example be a Fibre Channel interface or any other such block I/O type interface.

The storage system even further includes at least one NAS controller 108 that provide servers file-level access to the file systems through the first interface 105, at least one disk controller 110 that provide servers block-level access to the logical volumes 111a, 111b, 111c and physical volumes 113 through the second interface 106. The NAS controller 108 and the disk controller 110 can, for example, be physically and logically the same or different. A volume status table 109 is provided in the storage system 107 that stores statuses of physical volumes 113 and logical volumes 111a, 111b, 111c in the storage system 107 and is shared by all of the at least one NAS controller 108 and the at least one disk controller 110 in the storage system 107. An internal timer 114 is also provided in the storage system 107 that shows relative time or clock in the storage system 107.

As per the above, the server 101a is connected to the first interface 105 of the storage system 107 via the LAN 103 and the server 101b is connected to the second interface 106 of the storage system 107 via the SAN 104. Further, as per the above an example of the first interface is Ethernet. An example of the second interface is Fibre Channel. It is possible to use the same physical interface for the first interface 105 and the second interface 106. Ethernet is one example of this. In this case, two types of protocols run on Ethernet, NFS/CIFS protocols for file level I/Os and iSCSI protocol for block level I/Os.

FIG. 3 illustrates the contents of the volume status table 109 as having a plurality of entries which indicate the status of the various volumes in the storage system 107. The entries includes:

(A) Volume # 1091 which indicates an identification of a volume. A volume can be a logical volume or a physical volume.

(B) Type 1092 which indicates if a volume is a logical volume or a physical volume.

(C) First status 1093 which indicates if a volume is protected or not.

(D) Second status 1094 which indicates if a volume is exported or not.

(E) Third status 1095 which indicates a retention period of a volume, thereby defining how long the data is to be retained and thus when the volume can be written again.

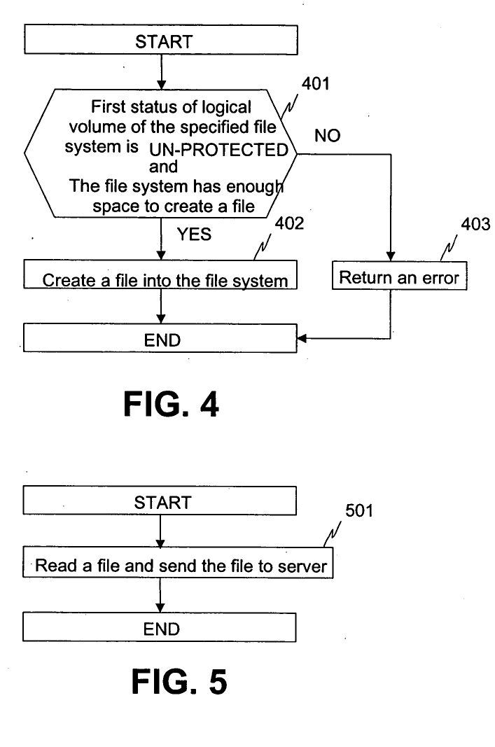

The NAS controller 108 presents the file systems to the server 101 a through the first interface 105. Particularly, the NAS controller 108 conducts various processes including file I/O requests issued by the server 101a via the first interface 105. These file I/O requests are described below and are illustrated in FIGS. 4-15.

Processing of the file create request as illustrated in FIG. 4 includes the following steps. If the first status of the logical volume of the specified file system is UN-PROTECTED and the file system has enough space to create a file (Step 401), the NAS controller creates a file in the file system (Step 402). If the first status of the logical volume of the specified file system is PROTECTED, then the NAS controller returns an error message to the requesting server (Step 403).

Processing of the file read request as illustrated in FIG. 5 includes the following step. The NAS controller sends the specified file in the specified file system to the requesting server (Step 501).

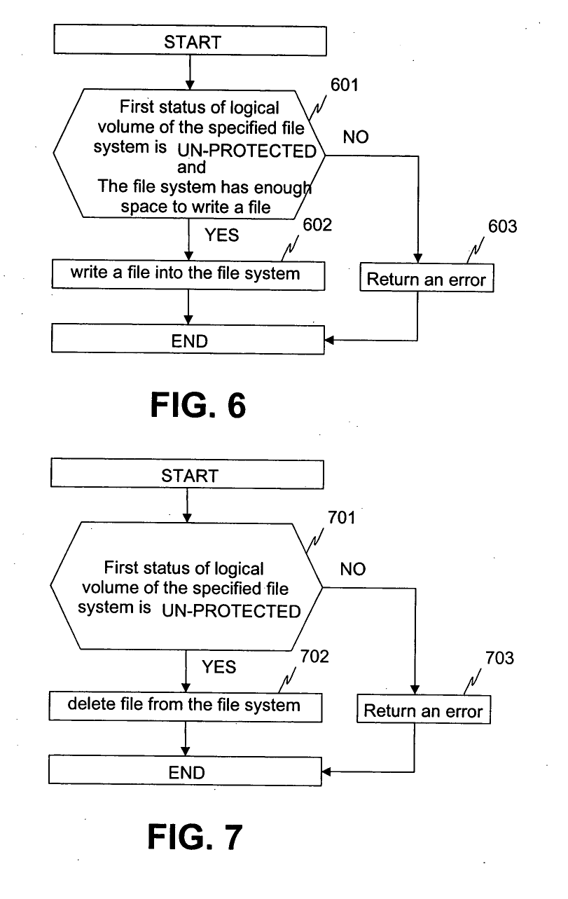

Processing of the file write request as illustrated in FIG. 6 includes the following steps. If the first status of the logical volume of the specified file system is UN-PROTECTED and the file system has enough space to write data (Step 601), the NAS controller writes the received data to the specified file (Step 602). If the first status of the logical volume of the specified file system is PROTECTED, then the NAS controller returns an error message to the requesting server (Step 603).

Processing of the file delete request as illustrated in FIG. 7 includes the following steps. If the first status of the logical volume of the specified file system is UN-PROTECTED (Step 701), then the NAS controller deletes the specified file from the file system (Step 702). If the first status of the logical volume of the specified file system is PROTECTED, the NAS controller returns an error message to the requesting server (Step 703).

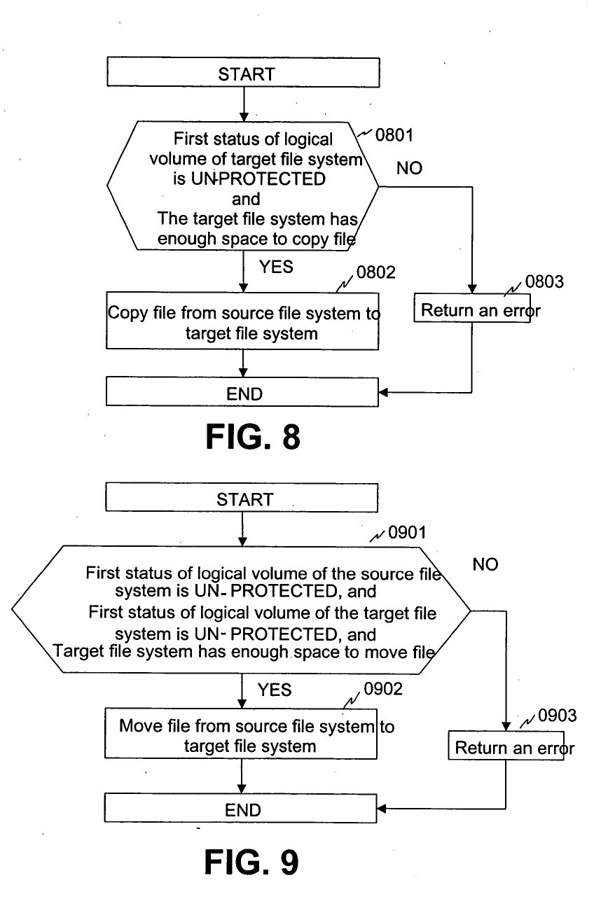

Processing of the file copy request as illustrated in FIG. 8 includes the following steps. If the first status of the logical volume of a target file system is UN-PROTECTED and the target file system has enough space to copy the specified file (Step 801), then the NAS controller 108 copies the specified file in a source file system to the specified location of the target file system (Step 802). If the first status of the logical volume of a target file system is PROTECTED, then the NAS controller returns an error message to the requesting server (Step 803).

Processing of the file move request as illustrated in FIG. 9 includes the following steps. If the first status of the logical volume of a source file system is UN-PROTECTED and the first status of the logical volume of a target file system is UN-PROTECTED and the target file system has enough space to move the specified file (Step 901), then the NAS controller copies the specified file in the source file system to the specified location of the target file system and then the NAS controller deletes the specified file from the source file system (Step 902). If the first status of the logical volume of a source file system is PROTECTED and the first status of the logical volume of a target file system is PROTECTED, then the NAS controller returns an error message to the requesting server (Step 903).

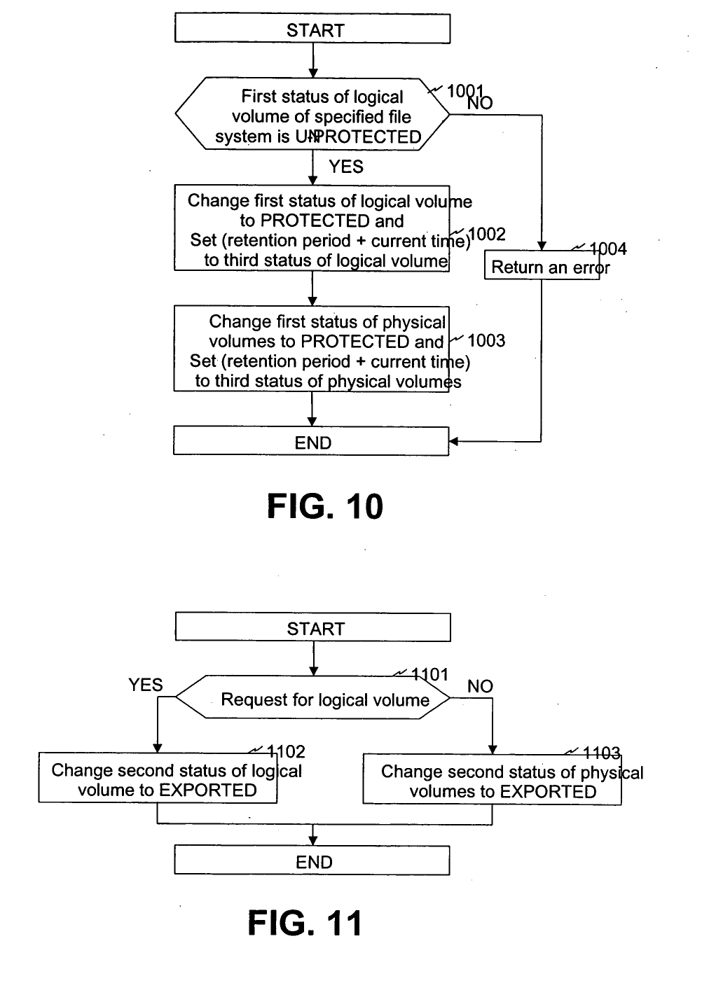

Processing of the file system protect request as illustrated in FIG. 10 includes the following steps. If the first status of the logical volume of the specified file system is UN-PROTECTED (Step 1001), then the NAS controller changes the first status of the logical volume of the specified file system to PROTECTED and sets the sum of the specified retention period and the current internal time to the third status of the logical volume (Step 1002). Thereafter, the NAS controller changes the first statuses of the physical volumes of the logical volume of the specified file system to PROTECTED and sets the sum of the specified retention period and the current internal time of the NAS controller to the third statuses of the physical volumes (Step 1003). If the first status of the logical volume of the specified file system is PROTECTED, then the NAS controller returns an error message to the requesting server. (Step 1004).

Processing of the file system export request as illustrated in FIG. 11 includes the following steps. If the request indicates a logical volume (Step 1101), then the NAS controller 108 changes the second status of the logical volume of the specified file system to EXPORTED (Step 1102). If the request indicates a physical volume, the NAS controller changes the second statuses of the physical volumes of the logical volume of the specified file system to EXPORTED (Step 1103).

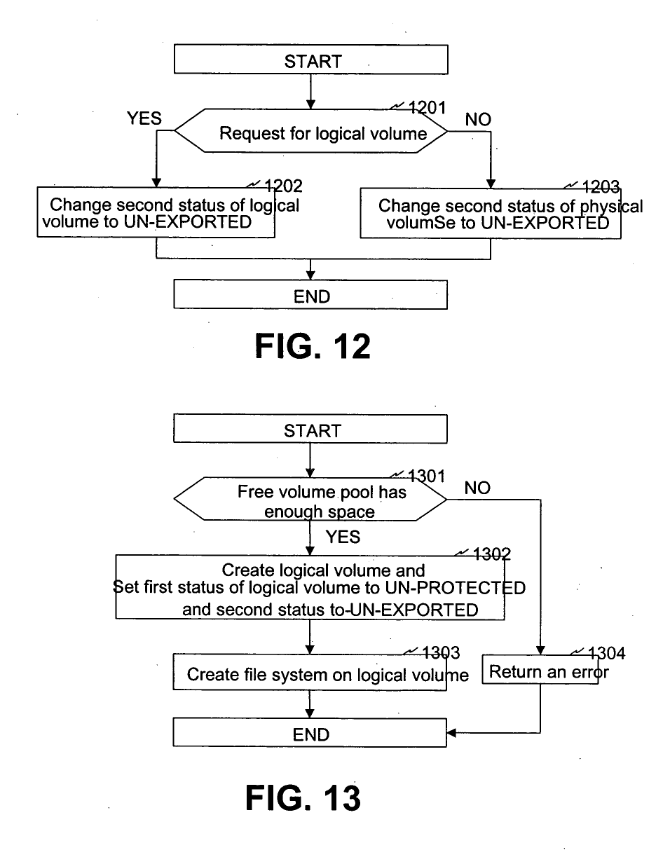

Processing of the file system un-export request as illustrated in FIG. 12 includes the following steps. If the request indicates a logical volume (Step 1201), then the NAS controller 108 changes the second status of the logical volume of the specified file system to UN-EXPORTED (Step 1202). If the request indicates a physical volume, then the NAS controller changes the second statuses of the physical volumes of the logical volume of the specified file system to UN-EXPORTED (Step 1203).

Processing of the file system create request as illustrated in FIG. 13 includes the following steps. If the free volume pool has enough physical volumes to create a logical volume according to the specified size (Step 1301), then the NAS controller creates a logical volume according to the specified size by using the selected physical volumes and sets the first status of the logical volume to UN-PROTECTED and the second status of the logical volume to UN-EXPORTED (Step 1302). Then the NAS controller creates a file system on the logical volume (Step 1303). If the free volume pool does not have enough physical volumes to create a logical volume according to the specified size, then the NAS controller returns an error message to the requesting server (Step 1304).

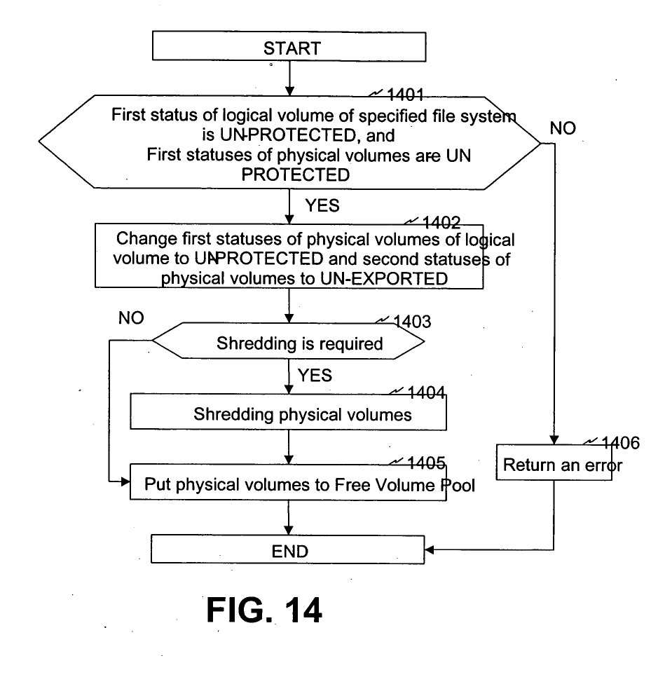

Processing of the file system delete request as illustrated in FIG. 14 includes the following steps. If the first status of the logical volume of the specified file system is UN-PROTECTED and all of the first statuses of the physical volumes of the logical volume of the specified file system are UN-PROTECTED (Step 1401), then the NAS controller 108 changes the first statuses of the physical volumes of the logical volume of the specified file system to UN-PROTECTED and changes the second statuses of the physical volumes to UN-EXPORTED (Step 1402). If requested shredding is required (Step 1403), then the NAS controller 108 deletes all of data on the physical volumes by shredding (Step 1404). If shredding is not required, then the NAS controller 108 places the physical volumes to the free volume pool for un-restricted use (Step 1405). If the first status of the logical volume of the specified file system is PROTECTED and all of the first statuses of the physical volumes of the logical volume of the specified file system are PROTECTED (Step 1401), then the NAS controller returns an error message to the requesting server (Step 1406).

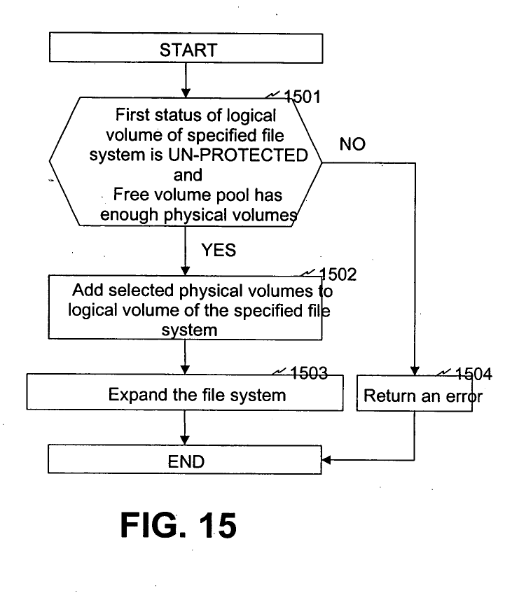

Processing of the file system expand request as illustrated in FIG. 15 includes the following steps. If the first status of the logical volume of the specified file system is UN-PROTECTED and the free volume pool has enough physical volumes to expand the file system (Step 1501), then the NAS controller 108 adds the selected physical volumes to the logical volume of the specified file system (Step 1502) and then expands the size of the file system (Step 1503). If the first status of the logical volume of the specified file system is PROTECTED, then the NAS controller 108 returns an error to the requesting server (Step 1504).

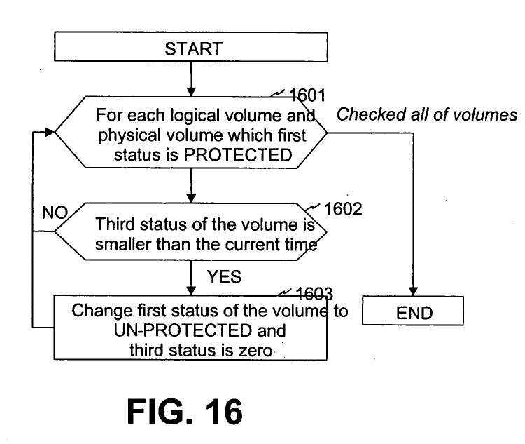

Processing of the expired date check procedure as illustrated in FIG. 16 includes the following steps. Check the first status for all of the logical volumes and the physical volumes to determine whether the first status of the volume is PROTECTED (Step 1601). Check if the third status of the volume is smaller than the current internal time of the storage system (Step 1602). If it is, the NAS controller changes the first status of the volume to UN-PROTECTED and the third status of the volume to zero (Step 1603).

Alternatively to the above, the disk controller can conduct the above file I/O processes instead of the NAS controller.

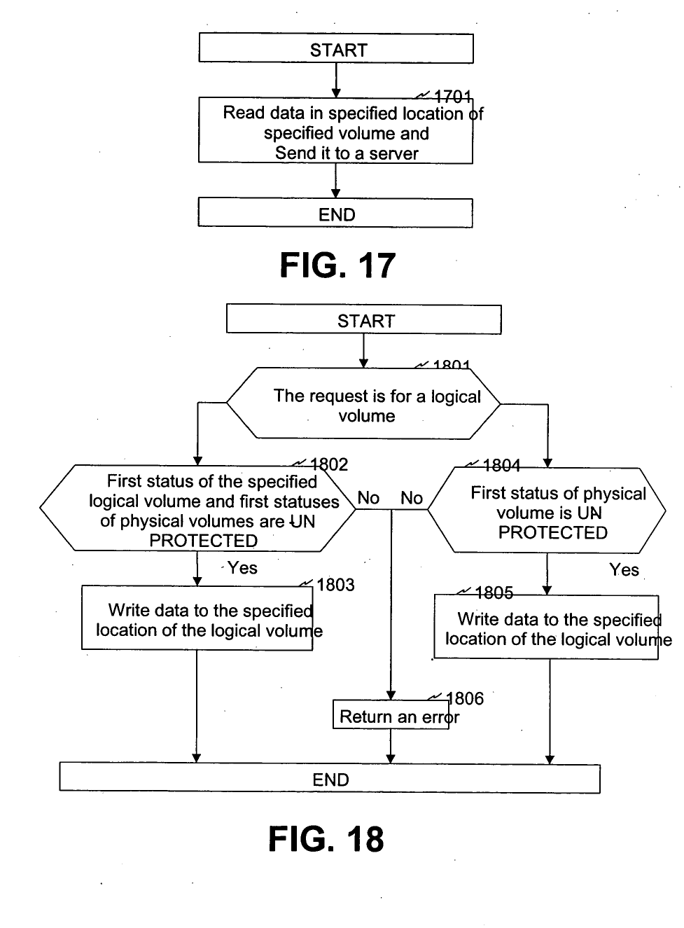

According to the first embodiment the disk controller 110 presents logical volumes and physical volumes through the second interface 106 if the second statuses of these volumes are EXPORTED, processes the following block I/O requests issued by the server 101b via the second interface 106. Particularly, the disk controller 106 conducts various processes including block I/O requests issued by the server 101b via the second interface 106. These block I/O requests are described below and are illustrated in FIGS. 17-18.

Processing of the data block read request as illustrated in FIG. 17 includes the following step. The disk controller reads data in the specified location of the specified logical or physical volume and sends it to the requesting server (Step 1701).

Processing of the data block write request as illustrated in FIG. 18 includes the following steps. If the request is for a logical volume (Step 1801), the disk controller checks if the first status of the specified logical volume and the first statuses of physical volumes of the logical volume are UN-PROTECTED (Step 1802). If the request is for a logical volume, then the disk controller writes the received data to the specified location of the specified logical volume (Step 1803). If the request is not for a logical volume, then the disk controller returns an error to the requesting server (Step 1806). If the request is for a physical volume, the disk controller checks if the first status of the specified physical volume is UN-PROTECTED (Step 1804). If the request is for a physical volume, then the disk controller writes the received data to the specified location of the specified physical volume (Step 1805). If the request is not for a physical volume, then the disk controller returns an error message to the requesting server (Step 1806).

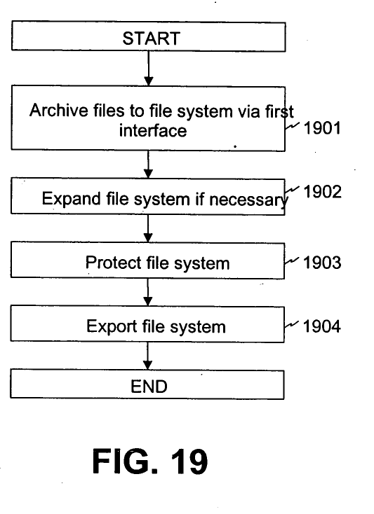

FIG. 19 illustrates one example of how to archive files including the following steps. A set of files is archived to the file system of the storage system via the first interface (Step 1901). The size of the file system is expanded if the size of the file system is smaller than the amount of the archived files (Step 1902). The file system is protected if the set of the files has been archived (Step 1903). The file system is exported (Step 1904). At this point, external servers can access the archived files via the second interface.

### EMBODIMENT 2

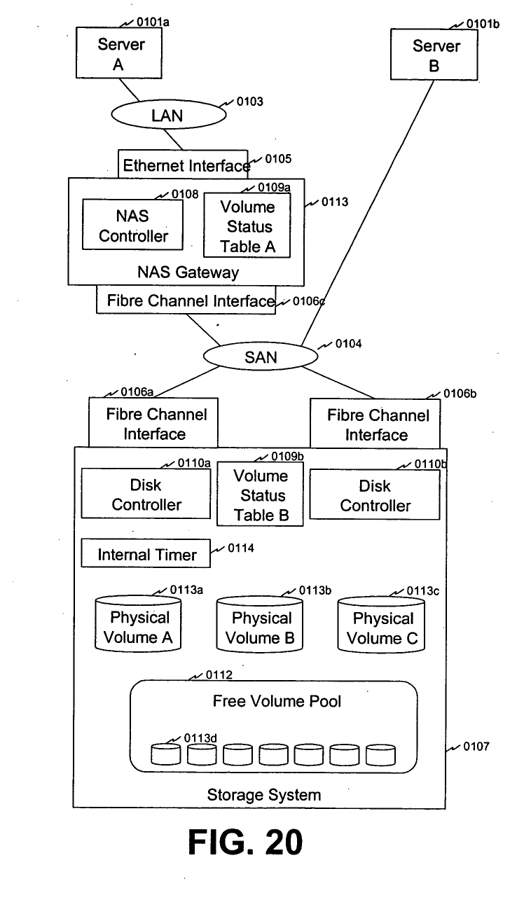

The second embodiment of the present invention as illustrated in FIG. 20 provides a storage system 107 which includes at least one second interface 106a and 106b for interfacing to a NAS gateway 115 via a SAN 104. The NAS gateway 115 interfaces to the SAN 104 via a second interface 106c and interfaces to a server A 101a via a first interface 105 and a LAN 103. The second interface 106c of the NAS gateway 115 could for example be a block I/O interface of a type different from the second interface 106a and 106b of the storage system 107. The second interface 106a and 106b of the storage system 107 also interfaces to a server B 101b via the SAN 104. Each of the servers 101a and 101b causes the storage system 107 by request to create, read, write, delete, copy, move and protect files.

The storage system 107 further includes at least one physical volume. In FIG. 20 the storage system 107 includes physical volume A 113a, physical volume B 113b and physical volume C 113c in which file systems are constructed and files are stored. The second interface 106a and 106b allow for block level access to the physical volumes 113a, 113b and 113c and the setting of the status of each of the physical volumes 113a, 113b and 113c.

The storage system still further includes a pool of physical volumes 113d that are not used for any purpose and as such are denoted as a free volume pool 112. The free volume pool 112 is managed by the NAS gateway 115.

The storage system even further includes at least one disk controller 110a and 110b that provides the servers with block-level access to physical volumes 113a, 113b, 113c through the second interface 106a and 106b, and a volume status table 109b that stores statuses of physical volumes 113a, 113b and 113c in the storage system 107 and is shared by all of the at least one disk controller 110a and 110b in the storage system 107. An internal timer 114 is also provided in the storage system 107 that shows relative time or clock in the storage system 107.

As per the above the server A 101a is connected to the first interface 105 of the of the NAS gateway 115 via the LAN 103 and the server B 101b is connected to the second interface 106a and 106b of the storage system 107 via the SAN 104. Further, as per the above an example of the first interface is Ethernet and an example of the second interface is Fibre Channel. Two types of protocols can run on Ethernet, NFS/CIFS protocols for file level I/Os and iSCSI protocol for block level I/Os.

The NAS gateway 115 includes at least one logical volume in which a file system is constructed and files are stored. A logical volume includes at least one physical volume 113a, 113b and 113c in the storage system 107. Information related to logical volumes and file systems are stored in physical volumes. The NAS gateway further includes at least one first interface 105 for server 101a to create, read, write, delete, copy, move and protect files, at least one NAS controller 108 that provides file-level access services to servers through the first interface 105, a volume status table 109a that stores statuses of logical volumes in the NAS gateway and is shared by all of the at least one NAS controllers 108 in the NAS gateway 115, and at least one second interface 106c to request the storage system 107 to perform reading, writing, shredding and protecting data in the physical volumes in the storage system 107 and setting statuses in volumes in the storage system.

The NAS controller 108 presents the file systems to server A 101a through the first interface 105. Particularly, the NAS controller 108 conducts various processes including file I/O requests issued by the server 101a via the first interface 105. These file I/O requests are the same as those described above and illustrated in FIGS. 4-15 with respect to the NAS controller included in the storage system 107. For some of file I/O requests, the NAS controller 108 included in the NAS gateway 115 sends a data block write request to the storage system 107 via the second interface 106c. If the NAS controller 108 receives an error message in a return from the storage system 107, then the NAS controller 108 interrupts the processing of file I/O request and sends an error message to the requesting server. The NAS controller 108 conducts each of the file I/O requests described above and illustrated in FIGS. 4-15 including file create, file read, file write, file delete, file copy, file move, file system protect requests, and file system expand requests, with the exception of the file system export, file system un-export, and file system delete requests.

With respect to the file system export request the NAS controller 108 changes the second statuses of the physical volumes of the logical volume of the specified file system to EXPORTED via the second interface 106c. With respect to the file system un-export request the NAS controller 108 changes the second statuses of the physical volumes of the logical volume of the specified file system to UN-EXPORTED via second interface 106c. With respect to the file system delete request, if all of the first statuses of the physical volumes of the logical volume of the specified file system are UN-PROTECTED, then the NAS controller 108 changes the first statuses of the physical volumes of the logical volume of the specified file system to UN-PROTECTED and the second statuses of the physical volumes to UN-EXPORTED by using the second interface 106c and if shredding required, then the NAS controller 108 deletes all of the data on the physical volumes by issuing a data shred request to the storage system and the NAS controller places the physical volumes to the free volume pool to permit un-restricted use.

Alternatively to the above, the disk controller can conduct the above described file I/O processes instead of the NAS controller.

According to the second embodiment the disk controller 110a and 110b present physical volumes through the second interface 106a and 106b if the second statuses of these volumes are EXPORTED, and processes the following block I/O requests issued by the server 101b or the NAS gateway 115 via the second interface 106a and 106b. Particularly, the disk controller 110a and 110b conducts various processes including block I/O requests issued by the server 101b or the NAS gateway 115 via the second interface 106a and 106b. These block I/O requests are the same as those described above and illustrated in FIGS. 17-18 with the exception of a data shred request which simply causes the disk controller 110a and 110b to delete data at a specified location of the specified physical volume.

For all of the physical volumes where the first status of the physical volume is PROTECTED, the disk controller checks whether the third status of the physical volume is smaller than the current internal time of the storage system. If it is, the disk controller changes the first status of the physical volume to UN-PROTECTED and the third status of the physical volume to zero.

Thus, as is clear from the above the first embodiment of the present invention provides a storage system and method for protecting data on a physical volume at the file system level and permitting access to the data at the physical volume level. The storage system includes a first interface for file level input/output (I/O), a second interface for block level I/O, a plurality of physical volumes upon which logical volumes are represented and which permits an appropriate sized file system to be created to store archived data, a first controller which processes file level I/O requests, and a second controller which processes block level I/O requests. The first and second controllers share protection information for said logical and physical volumes. Archived data is stored from the first interface and protected at the file system level, is accessed from both the first and second interfaces and is protected whichever interface is being used.

Further, as is clear from the above the second embodiment of the present invention provides a system and method for protecting data on a physical volume at the file system level and permitting access to the data at the physical volume level. The storage system includes a network attached storage (NAS) gateway, and a storage system which is connected to said NAS gateway. The NAS gateway includes a first interface for file level I/O, a third interface for block level I/O, and a first controller which processes file level I/O requests. The storage system includes a second interface for block level I/O, said second interface being connected to said third interface, a plurality of physical volumes upon which logical volumes are represented and which permits an appropriate sized file system to be created to store archived data, and a second controller which processes block level I/O requests. The first and second controllers share protection information for said logical and physical volumes. Archived data is stored from the first interface of the NAS gateway to the second interface via the third interface and protected at the file system level, is accessed from both said first and second interfaces and is protected whichever interface is being used.

The present invention provides an alternative configuration of the first and second embodiments described above wherein the first controller changes protection information for the logical and physical volumes to protect data. According to the alternative configuration the volume storing the protected data is protected from access from the second controller in accordance with the protection information

While the invention has been described in terms of its preferred embodiments, it should be understood that numerous modifications may be made thereto without departing from the spirit and scope of the present invention. It is intended that all such modifications fall within the scope of the appended claims.

1. A storage system for protecting data on a physical volume at the file system level and permitting access to the data at the physical volume level comprising:
a first interface for file level input/output (I/O);
a second interface for block level I/O;
a plurality of physical volumes upon which logical volumes are represented;
a first controller which processes file level I/O requests; and
a second controller which processes block level I/O requests,
wherein said first and second controllers share protection information for said logical and physical volumes, and
wherein archived data is stored from said first interface and protected at the file system level, is accessed from both said first and second interfaces and is protected whichever interface is being used.

2. A storage system according to claim 1, wherein the plurality of physical volumes permits an appropriate sized file system to be created to store archived data.

3. A storage system according to claim 2, wherein the shared protection information is a volume status table having a plurality of entries which indicate statuses of said physical and logical volumes.

4. A storage system according to claim 3, wherein said entries indicate whether a volume is a logical or physical volume.

5. A storage system according to claim 3, wherein said entries indicate a first status of each volume defining whether the volume is protected or unprotected.

6. A storage system according to claim 3, wherein said entries indicate a second status of each volume defining whether the volume is exported or un-exported.

7. A storage system according to claim 3, wherein said entries indicate a third status of each volume defining a retention period for the volume.

8. A storage system according to claim 8, wherein, after the retention period for the volume is expired, data in the volume can be changed by a request received at said first controller or said second controller.

9. A storage system according to claim 1, wherein said first controller is a network attached storage controller which processes file level I/O requests.

10. A storage system according to claim 1, wherein said second controller is a disk controller network attached storage controller which processes block level I/O requests.

11. A storage system according to claim 1, wherein said first interface is an Ethernet interface which processes file level I/O requests.

12. A storage system according to claim 1, wherein said second interface is a Fibre Channel interface which processes block level I/O requests.

13. A system for protecting data on a physical volume at the file system level and permitting access to the data at the physical volume level comprising:
a network attached storage (NAS) gateway; and
a storage system which is connected to said NAS gateway,
wherein said NAS gateway comprises:
a first interface for file level I/O,
a third interface for block level 1/0, and
a first controller which processes file level I/O requests,
wherein said storage system comprises:
a second interface for block level I/O, said second interface being connected to said third interface,
a plurality of physical volumes upon which logical volumes are represented, and
a second controller which processes block level I/O requests,
wherein said first and second controllers share protection information for said logical and physical volumes, and
wherein archived data is stored from said first interface of said NAS gateway to said second interface via said third interface and protected at the file system level, is accessed from both said first and second interfaces and is protected whichever interface is being used.

14. A system according to claim 13, wherein the plurality of physical volumes and which permits an appropriate sized file system to be created to store archived data.

15. A storage system according to claim 14, wherein the shared protection information is a volume status table having a plurality of entries which indicate statuses of said physical and logical volumes.

16. A storage system according to claim 15, wherein said entries indicate whether a volume is a logical or physical volume.

17. A storage system according to claim 15, wherein said entries indicate a first status of each volume defining whether the volume is protected or unprotected.

18. A storage system according to claim 15, wherein said entries indicate a second status of each volume defining whether the volume is exported or un-exported.

19. A storage system according to claim 15, wherein said entries indicate a third status of each volume defining a retention period for the volume.

20. A system according to claim 19, wherein, after the retention period for the volume is expired, data in the volume can be changed by a request received at said first controller or said second controller.

21. A storage system according to claim 13, wherein said first controller is a network attached storage controller which processes file level I/O requests.

22. A storage system according to claim 13, wherein said second controller is a disk controller network attached storage controller which processes block level I/O requests.

23. A storage system according to claim 13, wherein said first interface is an Ethernet interface which processes file level I/O requests.

24. A storage system according to claim 13, wherein said second interface is a Fibre Channel interface which processes block level I/O requests.

25. A storage system for protecting data on a physical volume at the file system level and permitting access to the data at the physical volume level comprising:
a first interface for file level input/output (I/O);
a second interface for block level I/O;
a plurality of physical volumes upon which logical volumes are represented;
a first controller which processes file level I/O requests; and
a second controller which processes block level I/O requests,
wherein said first controller changes protection information for said logical and physical volumes to protect data,
wherein the volume storing the protected data is protected from access from said second controller in accordance with the protection information.

26. A storage system according to claim 25, wherein the protection information is a volume status table having a plurality of entries which indicate statuses of said physical and logical volumes.

27. A storage system according to claim 26, wherein said entries indicate a first status of each volume defining whether the volume is protected or unprotected.

28. A storage system according to claim 26, wherein said entries indicate a second status of each volume defining whether the volume is exported or un-exported.

29. A storage system according to claim 25, wherein said first controller is a network attached storage controller which processes file level I/O requests.

30. A storage system according to claim 25, wherein said second controller is a disk controller network attached storage controller which processes block level I/O requests.

31. A storage system according to claim 25, wherein said first interface is an Ethernet interface which processes file level I/O requests.

32. A storage system according to claim 25, wherein said second interface is a Fibre Channel interface which processes block level I/O requests.
